(19) United States
(12) Patent Application Publication
(10) Pub. No.: US 2003/0135702 A1
(43) Pub. Date: Jul. 17, 2003

(54) Microcomputer for accessing a replacing block area preset in a nonvolatile memory in place of a replaced block area accessed in the nonvolatile memory

(76) Inventors: Katsunobu Hongo, Tokyo (JP); Tsutomu Tanaka, Tokyo (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 10/191,315

(22) Filed: Jul. 10, 2002

(30) Foreign Application Priority Data
Jan. 16, 2002 (JP) 2002-7866

(51) Int. Cl. G06F 12/12

(52) U.S. Cl. 711/159; 711/102

(57) ABSTRACT

Data are written in a plurality of block areas of a one-time program ROM including a replaced block area having bugs, and correction data desired to be stored in the replaced block area is written in a replacing block area of the one-time program ROM. Bits indicating a block address of a replaced block area having bugs are written in a replaced address register. When bits indicating a block address of a currently accessed block area agrees with those of the replaced block area in an address comparator, the access to the replaced block area is inhibited, the replacing block area is accessed, and the correction data of the replaced block area is read out from the replacing block area in place of the replaced block area.

### BACKGROUND OF THE INVENTION

1Field of the Invention

The present invention relates to a microcomputer having a nonvolatile memory, and more particularly to a microcomputer having a read only memory (ROM) such as one-time program ROM (one-time program ROM) in which data can be written only once and the data cannot be erased.

2. Description of Related Art

Various microcomputers respectively have a one-time program ROM as a mask ROM, and a type of microcomputer among the microcomputers has a function for correcting bugs existing in data of the RON. To obtain a ROM data correction function in a microcomputer, the microcomputer has a ROM correction address register, a ROM correction data register, a ROM correction enable register and a ROM correction control circuit. An address of ROM data having bugs is set in the ROM correction address register, and correction data desired to be stored in a memory area of the ROM placed at the address is stored in the ROM correction data register. In the ROM correction control circuit, it is detected whether or not an address currently specified to read out data from a ROM agrees with the setting address set in the ROM correction address register. In case of the agreement of the currently specified address with the setting address, the correction data of the ROM correction data register is used in place of data read out from the ROM. In addition, to obtain the ROM data correction function in the microcomputer, it is required that an external memory such as an electrically erasable/programmable read only memory (EEPROM) is connected to the microcomputer, a control program such as a program for controlling a serial I/O used for an EEPROM interface is written in the ROM in advance, and a program for the ROM data correction is written in the external memory in advance. For example, a bug is generated at an address “1000h” of the ROM, and it is required to correct original data of a memory area of the address to “98h”. In this case, a setting address “1000h” and correction data “98h” are written in the external EEPROM, and a predetermined terminal of the microcomputer is set in advance to a state of “ROM correction” (for example, a high level). When an operation of the microcomputer is started after resetting the microcomputer, ROM data correction processing is performed in the microcomputer in response to the terminal state “ROM correction” of the predetermined terminal set in advance.

In the ROM data correction processing performed in the microcomputer, the serial I/O used for an interface with the external EEPROM is set and operated, address data “1000h” of the external EEPROM is written in the ROM correction address register through the serial I/O, and the correction data “98h” of the external EEPROM is written in the ROM correction data register. In addition, data indicating “ROM correction use enabling” is written in the ROM correction enable register (as is described above, the control program for controlling the serial I/O for the ROM correction processing is written in advance in the ROM).

As is described above, when the setting of the ROM correction address register, the ROM correction data register and the ROM correction enable register is completed, the ROM correction control circuit is set in a standby state. Thereafter, each address output from a central processing unit (CPU) is checked in the ROM correction control circuit. When an address output from the CPU agrees with the address data “1000h” set in the ROM correction address register, a value (or data) planned to be read out from a memory area of the address of the ROM is replaced in the ROM correction control circuit with the correction data “98h” set in the ROM correction data register. In this case, when a read operation is performed for the memory area of the address of the ROM, no read operation is performed for the ROM, and the read operation is performed for the ROM correction data register to read out the correction data “98h”. Accordingly, erroneous data based on the bugs existing in the memory area of the address “1000h” can be replaced with the correction data “98h”.

In the Published Unexamined Japanese Patent Application No. 2000-267846, a method of programming a one-time program of a one-time program ROM again without wasting a memory area is disclosed. For example, in this Application, a bug area of the program is replaced with a memory area of an arbitrary address other than a programming area of the one-time program.

However, because the above-described ROM data correction function is directed to a ROM, in which it is impossible to add new data, in the conventional microcomputer, it is required that the conventional microcomputer has the group of registers including the ROM correction address register, the ROM correction data register and the ROM correction enable register and the ROM correction control circuit. Therefore, a problem has arisen that the configuration of the conventional microcomputer is complicated and a chip area of the conventional microcomputer is increased.

Also, because it is required of a user that an external memory such as EEPROM is connected to the conventional microcomputer, it is troublesome for the user to use the ROM data correction function. Also, because an amount of data possible to be corrected is limited within one byte determined by the ROM correction data register, a problem has arisen that a size of each bug possible to be corrected is limited.

In addition, in the method disclosed in the Published Unexamined Japanese Patent Application No. 2000-267846, because a bug area of a program is replaced with a memory area of an arbitrary address other than a programming area of the one-time program, a problem has arisen that a circuit size of the ROM is inevitably enlarged.

### SUMMARY OF THE INVENTION

An object of the present invention is to provide, with due consideration to the drawbacks of the conventional microcomputer, a microcomputer in which correction of erroneous data based on a bug of a ROM is easily performed without enlarging a circuit size of the ROM.

Also, a subordinate object of the present invention is to provide a microcomputer in which erroneous data based on bugs of a ROM is corrected regardless of an amount of the bugs.

The object is achieved by the provision of a microcomputer including a nonvolatile memory having a plurality of block areas and a replacement information area in which first address information specifying a replaced block area included in the block areas, address information comparing means for comparing the first address information with second address information indicating each block area of the nonvolatile memory currently accessed, and access means for gaining access to one block area of the nonvolatile memory set in advance as a replacing block area in place of the access to the accessed block area indicated by the second address information in case of the agreement of the first address information with the second address information.

Therefore, the access means gains access to the replacing block area in place of the access to the accessed block area (or the replaced block area), and data written in the replacing block area is read out. Accordingly, a user can easily remove an adverse influence of bugs existing in the replaced block area on the operation of the microcomputer.

To achieve the subordinate object of the present invention, it is preferred that the first address information stored in the replacement information area of the nonvolatile memory includes extension information which specifies a plurality of specific block areas including the replaced block area and successively arranged with each other in the nonvolatile memory as a plurality of replaced block areas, the first address information specifying each replaced block area is compared with the second address information by the address information comparing means, and the access means gains access to one block area of the nonvolatile memory set in advance as a replacing block area in place of the access to each replaced block area indicated by the extension information of the first address information.

Therefore, even though bugs are generated in a specific block area of the nonvolatile memory to a large degree so as to make impossible to write correction data of the specific block area having the bugs in one replacing block area, the number of replaced block areas can be arbitrarily increased according to an amount of bugs. Therefore, the correction data of the specific block area having the bugs and data of another specific block area (or other specific block areas) successively arranged with the specific block area having the bugs can be written in a plurality of replaced block areas.

Also, because a plurality of comparing devices are not required as the address information comparing means to perform the access to the replacing block areas in place of the access to the replaced block areas, a chip area required of the microcomputer can be reduced.

### BRIEF DESCRIPTION OF THE DRAWINGS

FIG. 1 is a block diagram of a microcomputer according to first to sixth embodiments of the present invention;

FIG. 2 is a constitutional view showing a replaced address register shown in FIG. 1;

FIG. 3 is a constitutional view showing an address comparator shown in FIG. 1;

FIG. 4 is a constitutional view showing a word line decoder shown in FIG. 1 according to the first embodiment;

FIG. 5 shows a memory map of a memory cell array of a one time program ROM shown in FIG. 1 according to the first embodiment;

FIG. 6 shows a memory map of the memory cell array of the one-time program ROM shown in FIG. 1 according to a second embodiment of the present invention;

FIG. 7 is a constitutional view showing the word line decoder shown in FIG. 1 according to the second embodiment;

FIG. 8 is a constitutional view showing the word line decoder shown in FIG. 1 according to a third embodiment;

FIG. 9 is a constitutional view showing the replaced address register shown in FIG. 1 according to a fourth embodiment;

FIG. 10 is a constitutional view showing the address comparator shown in FIG. 1 according to the fourth embodiment;

FIG. 11 is a constitutional view showing the word line decoder shown in FIG. 1 according to a fourth embodiment;

FIG. 12 is a constitutional view showing the replaced address register shown in FIG. 1 according to a fifth embodiment;

FIG. 13 is a constitutional view showing the word line decoder shown in FIG. 1 according to the fifth embodiment; and

FIG. 14 is a constitutional view showing the replaced address register shown in FIG. 1 according to a sixth embodiment.

### DETAILED DESCRIPTION OF THE PREFERRED EMBODIMENTS

Embodiments of the present invention will now be described with reference to the accompanying drawings.

Embodiment 1

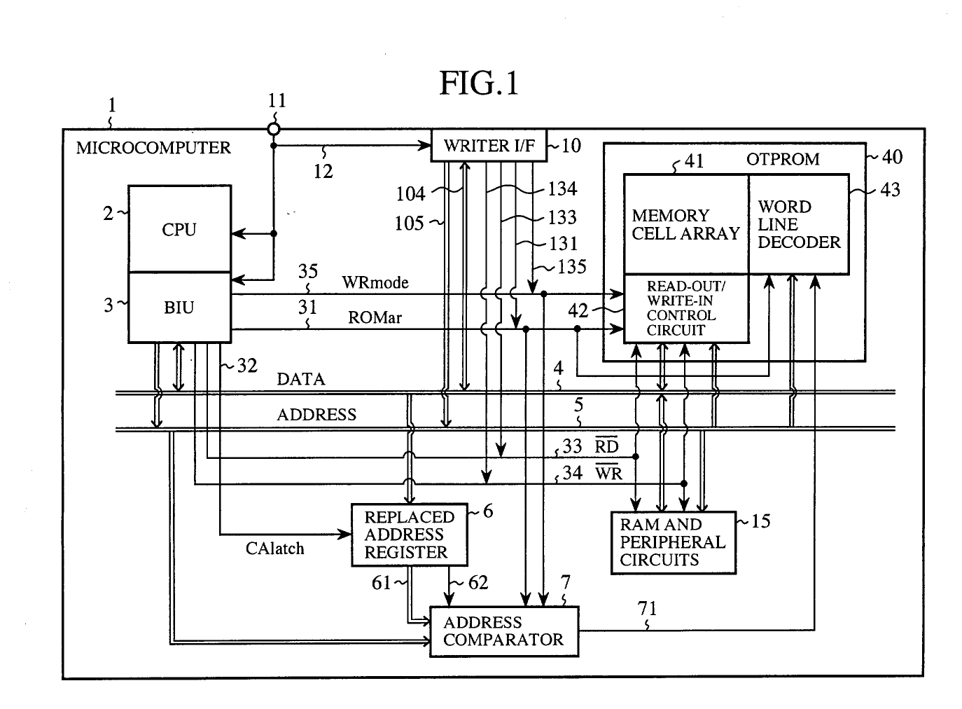

FIG. 1 is a block diagram of a microcomputer according to a first embodiment of the present invention. In FIG. 1, 1 indicates a microcomputer according to a first embodiment. 2 indicates a central processing unit (CPU). 3 indicates a bus interface unit (BIU). 4 indicates a data bus. 5 indicates an address bus. 40 indicates a one-time program ROM (one-time program ROM). 6 indicates a replaced address register (or address information setting means). 7 indicates an address comparator (or address information comparing means). 10 indicates a writer interface (I/F) circuit. 11 indicates a mode selection terminal. 15 indicates a random access memory (RAM) and a peripheral circuit.

An access timing of the CPU 2 to the data bus 4 is adjusted in the bus interface unit 3, and the bus interface unit 3 is connected to both the data bus 4 and the address bus 5. Each of a read signal (RD) 33, a write signal (WR) 34, a write mode signal (WRmode) 35, a ROM area access signal (ROMar) 31 and a replaced address register latch signal (CAlatch) 32 is output at a prescribed timing under control of the bus interface unit 3. Each of these signals is sometimes called a control signal.

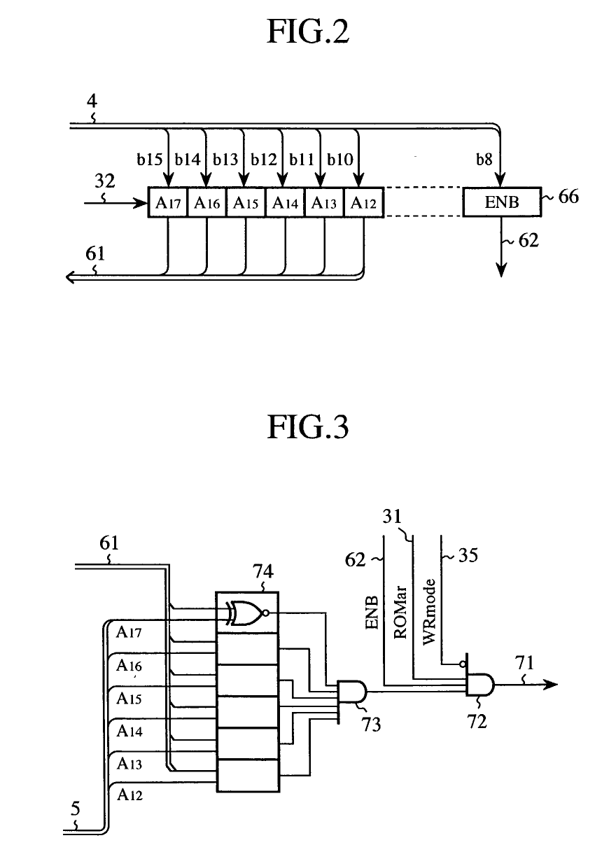

In the one-time program ROM 40, a memory cell array 41 (or a nonvolatile memory), a read-out/write-in control circuit (or access means) 42 and a word line decoder (or access means) 43 are arranged. FIG. 2 is a constitutional view showing the replaced address register 6 shown in FIG. 1. In FIG. 2, the replaced address register 6 has an eight-bit register 66 having one empty bit. Six bits b15, b14, b13, b12, b11 and b10 indicating a replaced block area and one bit b8 indicating replacement enabling described later in detail are sent through the data bus 4 and are latched in the replaced address register 6 according to a latch signal 32. Six bits A17 to A12 corresponding to the latched bits b15 to b10 are output as an replaced address register output 61 (or first address information), and a bit ENB corresponding to the latched bit b8 is output as a replacement enable signal 62. The replaced address register output 61 indicates a block address of a replaced block area, and the replaced block area is planned to be replaced with a replacing block area. The replacement enable signal 62 set to a high level (or an active level) indicates the replacement enabling.

FIG. 3 is a constitutional view showing the address comparator 7. In FIG. 3, the address comparator 7 is composed of a comparing circuit 74 having a plurality of EX-NOR gates (six EX-NOR gates in FIG. 3), an AND gate 73 and an AND gate 72. In the comparing circuit 74, the bits A17 to A12 of the replaced address register output 61 and bits A17 to A12 (or second address information) of address data currently sent through the address bus 5 are input, and a plurality of comparison result signals are output. The bits A17 to A12 currently sent through the address bus 5 indicate a 4 k-byte memory area of the memory cell array 41 currently accessed. The comparison result signals output from the comparing circuit 74 are input to the AND gate 73, and a logical multiply of the comparison result signals is obtained. The logical multiply, obtained in the AND gate 73 is output as an AND signal. In cases where the bits A17 to A12 of the replaced address register output 61 agree with the bits A17 to A12 of the address data currently sent through the address bus 5 respectively, the comparison result signals are respectively set to the high level “1”, and the AND signal is set to the high level “1”. In contrast, in cases where at least one bit of the replaced address register output 61 does not agree with the corresponding bit of the address data currently sent through the address bus 5, the AND signal is set to the low level “0”. In the AND gate 72, the replaced address register output 62 and the ROM area access signal (ROMar) 31 are received, the write mode signal (WRmode) 35 is received through an inverter, the AND signal output from the AND gate 73 is received, and a logical multiply of the replaced address register output 62, the ROM area access signal (ROMar) 31, the inverted write mode signal (WRmode) 35 and the AND signal is obtained. The logical multiply of the AND gate 72 is output as an address identity signal 71. Therefore, in cases where the bits A17 to A12 of the replaced address register output 61 agree with the bits A17 to A12 of the address data currently sent through the address bus 5 respectively, the address identity signal 71 is set to the high level “1” on condition that the access to the ROM area 44, the replacement enabling and a normal operating mode different from the write mode are set. In other cases, the address identity signal 71 is set to the low level “0”.

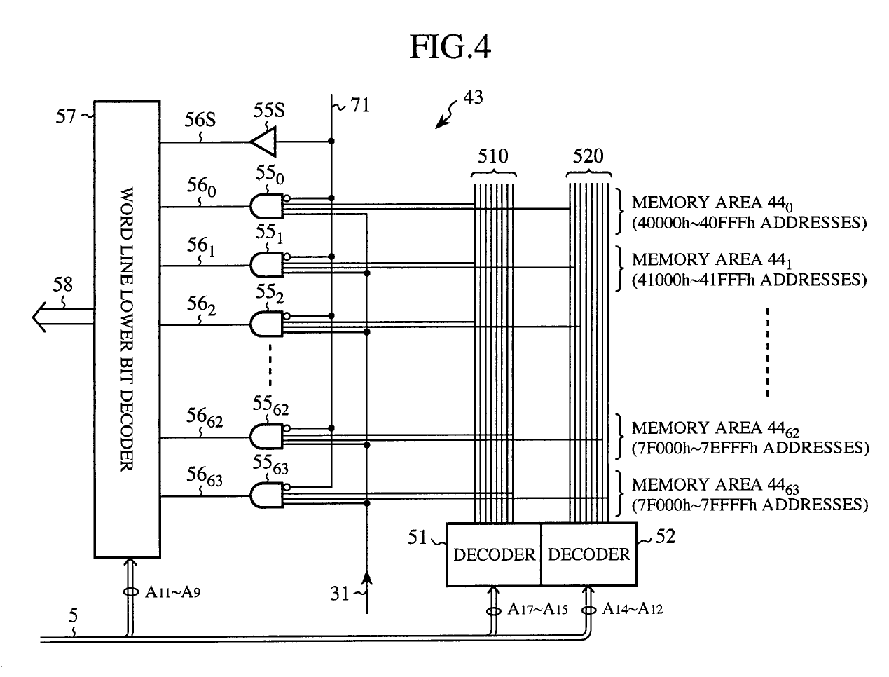

FIG. 4 is a constitutional view showing the word line decoder 43 according to the first embodiment. In FIG. 4, the word line decoder 43 is composed of a decoder 51, a decoder 52, a buffer gate 55S, a plurality of AND gates 55n (55₀, 55₁, 55₂, - -, 55₆₂ and 55₆₃ in FIG. 4) corresponding to 4 k-byte memory areas 44n respectively and a word line lower bit decoder 57. In the decoder 51, bits A17 to A15 of the address data currently sent through the address bus 5 are decoded, and eight (2³) decoder outputs 510 are output. In the decoder 52, bits A14 to A12 of the address data currently sent through the address bus 5 are decoded, and eight (2³) decoder outputs 520 are output. In the buffer gate 55S, the address identity signal 71 is received, and a buffering signal 56S is output to the word line lower bit decoder 57. In each AND gate 55n corresponding to one 4 k-byte memory area 44n, the address identity signal 71 is received through an inverter, the ROM area access signal (ROMar) 31 is received, one decoder output 510 and one decoder output 520 corresponding to the block address of the 4 k-byte memory area 44n are received, and an AND signal 56n is output to the word line lower bit decoder 57. In the word line lower bit decoder 57, bits A11 to A9 of the address data currently sent through the address bus 5 are received, an address decode signal is produced according to one AND signal 56n or the buffering signal 56S, and the address decode signal is output to the memory cell array 41 through a word line 58.

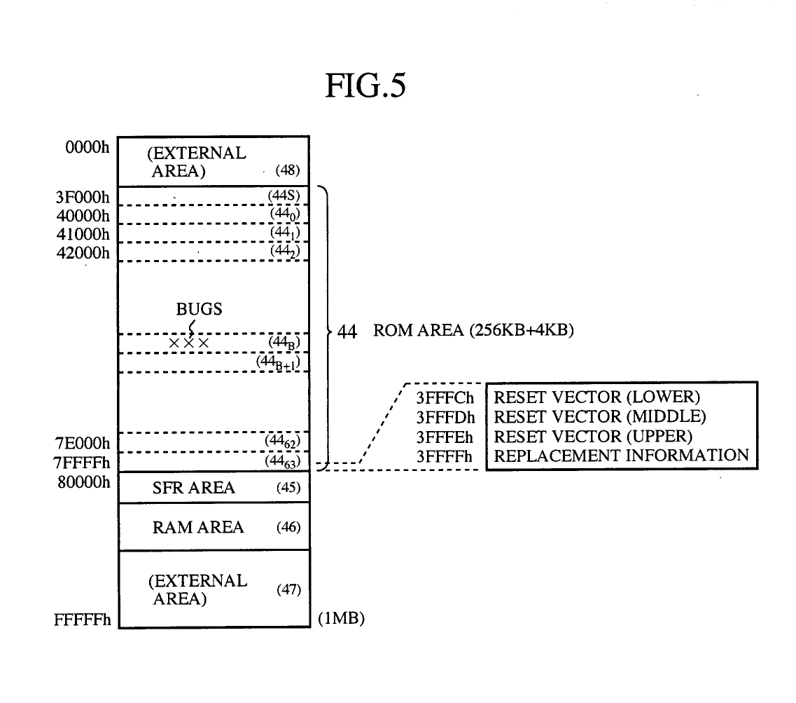

The microcomputer 1 has the memory cell array 41 of the one-time program ROM 40 indicated by a memory map shown in FIG. 5. An address space of the microcomputer 1 has 1 M-bytes ranging from a “00000h” address to an “FFFFFh” address, and 256 k-bytes of the address space ranging from a “40000h” address to a “7FFFFh” address and 4 k-bytes of the address space ranging from a “3F000h” address to a “3FFFFh” address are allocated to a ROM area 44. The ROM area 44 is divided into a plurality of block areas having the same number of bytes. In this embodiment, the ROM area 44 is divided into a 4 k-byte memory area (or a block area) 44S and sixty-four 4 k-byte memory areas (or block areas) 44n (44₀, 44₁, 44₂, - - , 44₆₂ and 44₆₃). The 4 k-byte memory areas 44S and 44n relate to the buffer gate 55S and the AND gates 55n in one-to-one correspondence. Also, three reset vectors (lower, middle and upper) and replacement information (or first address information) indicating the bits b15 to b10 and b8 shown in FIG. 2 are stored in a 4 byte memory area (“3FFFCh” address to “3FFFFh” address) of the 4 k-byte memory area 44S of the ROM area 44. The 4 byte memory area (“3FFFCh” address to “3FFFFh” address) of the 4 k-byte memory area 44S is used only for the block area replacement operation, and it is impossible to read out data (three reset vectors and replacement information) of the 4 byte memory area to the CPU 2.

Also, there are an SFR area 45, a RAM area 46 and external areas 47 and 48 in the address space, and the areas 45 to 48 are used for peripheral circuits such as a timer, a serial I/O and an analog-to-digital (A/D) converter.

Next, an operation of the microcomputer 1 will be described below.

In cases where pieces of data (or a control program) are written in the memory cell array 41 of the one-time program ROM 40, a writer (not shown) is connected to the writer I/F circuit 10 of the microcomputer 1. In this case, the mode selection terminal 11 is set to a write mode specifying state (for example, a high level). Therefore, the write mode signal (WRmode) 35 is set to a high level, the writer I/F circuit 10 is set to an operating state, and the CPU 2 and the bus interface unit 3 are respectively set to a stopped state. In contrast, in cases where the mode selection terminal 11 is set to a normal mode (for example, a low level), various control signals are output from the bus interface unit 3.

When the writer I/F circuit 10 is set to the operating state, writer data 104 is sent from the writer I/F circuit 10 to the data bus 4, a writer address 105 is sent from the writer I/F circuit 10 to the address bus 5, and a plurality of writer control signals 133, 134, 135 and 131 (a read signal (RD) 133, a write signal (WR) 134, a write mode signal (WRmode) 135 and a ROM area access signal (ROMar) 131) are output from the writer I/F circuit 10 in place of the control signals 33, 34, 35 and 31 output from the bus interface unit 3. In detail, in the writer I/F circuit 10, the write mode signal (WRmode) 135 and the ROM area access signal (ROMar) 131 are respectively set to an active state, an address and data to be written are set as a writer address 105 and writer data 104 respectively, and the writer address 105 and the writer data 104 are sent to the address bus 5 and the data bus 4 respectively. Thereafter, the write signal (WR) 134 is set to an active state, the operation of the read-out/write-in control circuit 42 is started, and the writer data 104 is written at the writer address 105 of the ROM area 44 of the one-time program ROM 40 in a data writing operation.

This data writing operation is repeatedly performed while changing the writer address 105 and the writer data 104, and pieces of writer data are written in the ROM area 44 (256 k-bytes ranging from the “40000h” address to the “7FFFFh” address). Therefore, the pieces of writer data 104 denoting a control program are written in the one-time program ROM 40. In this case, three reset vectors are written in a memory area of the addresses “3FFFCh” to “3FFFEh” of 3 bytes, and no data is written in a memory area (or replacement information area) of the address “3FFFFh”. That is, the memory area of the address “3FFFFh” is set to be blank.

In this embodiment, the pieces of writer data 104 of the writer I/F circuit 10 are directly written in the one-time program ROM 40 without operating the CPU 2. However, it is applicable that the pieces of writer data 104 be written in the one-time program ROM 40 by using the CPU 2. In this case, the pieces of writer data 104, the writer addresses 105 and the writer control signals 133, 134, 135 and 131 are output from the bus interface unit 3 to the one-time program ROM 40.

After the pieces of writer data 104 are written in the ROM area 44 of the one-time program ROM 40, bugs of the control program (or the pieces of writer data 104) are detected according to the first embodiment. As shown in FIG. 5, bugs are, for example, detected in a specific 4 k-byte memory area (called a replaced block area) 44_{B}. In this case, bits b15 to b10 indicating the block address of the replaced block area 44_{B} and a replacement enable bit b8 set to “1” denoting the replacement enabling are additionally written as replacement information in the replacement information area of the address “3FFFFh” of the ROM area 44. As is described later, when the operation of the microcomputer 1 is started at a normal operating mode, the replacement information (the bits b15 to b10 and b8) are stored in the replaced address register 6 as the bits A17 to A12 indicating the block address of the replaced block area 44_{B} and the replacement enable bit ENB, and correction data, with which erroneous data of the replaced block area 44_{B} is replaced, is written in the 4 k-byte memory area 44S denoting a replacing block area.

As is described above, after the additional writing of the replacement information indicating the replaced block area 44_{B} and the replacement enable bit, the operation of the microcomputer 1 is started at a normal operating mode different from a writing mode. Therefore, the reset vectors, the replacement information indicating the replaced block area 44_{B} and the replacement enable bit are read out from the addresses “3FFFCh” to “3FFFFh” of the one-time program ROM 40 to the bus interface unit 3. The reset vectors (lower, middle and upper) are taken in the bus interface unit 3 and is used as a next access address.

In contrast, when the replacement information stored in the address “3FFFFh” of the ROM area 44 is read out from the one-time program ROM 40 to the data bus 4, the replacement information is latched by the replaced address register 6 (that is, the register 66) according to the replaced address register latch signal (CAlatch) 32 output from the bus interface unit 3 simultaneous with the start of the reading-out of the control program stored in the ROM area 44. As a result, the replacement enable bit ENB of the register 66 is set to “1”, and the replacement enabling signal 62 set to “1” and the replaced address register output 61 (the bits A17 to A12 indicating the block address of the replaced block area 44_{B}) are output from the replaced address register 6 to the address comparator 7.

The microcomputer 1 is operated according to the control program stored in the ROM area 44 of the one-time program ROM 40. In cases where the bus interface unit 3 gains access to a 4 k-byte memory area 44i (“i” denotes an integral number ranging from 0 to 63) having no bug during the operation of the microcomputer 1, the comparing circuit 74 of the address comparator 7 is set to an inactive state. Therefore an address identity signal 71 set to an active level “1” is not output from the address comparator 7. In other words, an address identity signal 71 set to an inactive level “0” is output.

When the address identity signal 71 is set to an inactive level, the buffer gate 55S of the word line decoder 43 shown in FIG. 4 is set to an inactive state, and a buffering signal 56S set to an inactive level “0” is output. In contrast, because the address identity signal 71 is received in each of the AND gates 55n through an inverter, each AND gate 55n is released from the inhibit condition. Therefore, in cases where the ROM area access signal (ROMar) 31 is set in an effective level (or a ROM access level), the AND gate 55i corresponding to the 4 k-byte memory area 44i specified by the bits A17 to A12 of address data currently sent through the address bus 5 is set to an active state. This AND gate 55i is called an active AND gate 55i. Thereafter, an AND signal 56i set to the active level “1” is output from the active AND gate 55i, and a word line 58 corresponding to both the AND signal 56i and a group of bits A11 to A9 of the address data currently sent through the address bus 5 is set to an active level.

In contrast, when the bus interface unit 3 gains access to the 4 k-byte memory area (or the replaced block area) 44_{B} having bugs during the operation of the microcomputer 1, a group of bits A17 to A12 of address data currently sent through the address bus 5 agrees with the replaced address register output 61 indicating a group of bits A17 to A12 corresponding to the 4 k-byte memory area 44_{B}, the access to the 4 k-byte memory area 44_{B} is detected in the comparing circuit 74. Therefore, the AND signal output from the AND gate 73 is set to the high level (or active level). In cases where the ROM area access signal (ROMar) 31 is set in an effective level (or a ROM access level), the address identity signal 71 is set to the high level (or active level). Here, in cases where the microcomputer 1 is operated in the writing mode, the write mode signal (WRmode) 35 is set to the high level, and the AND gate 72 receiving the inverted write mode signal (WRmode) 35 is set to an inhibit state. Therefore, the address identity signal 71 is not set to the active level even though the ROM area access signal (ROMar) 31 set in an effective level and the replaced address register output 62 set to “1” are received in the AND gate 72.

Therefore, when the bus interface unit 3 intends to gain access to an memory area of the replaced block area 44_{B} having bugs at the normal operation mode different from the writing operation mode, the address identity signal 71 output from the address comparator 7 to the word line decoder 43 is set to the active level, the buffer gate 55S of the word line decoder 43 shown in FIG. 4 is set to the active state to output the buffering signal 56S set to the active level “1”, and the AND gates 55n of the word line decoder 43 are set to the inhibiting state. In this case, a word line 58 of a memory area of the replacing block area 44S corresponding to the memory area of the replaced block area 44_{B} is specified by both the AND signal 56S output from the buffer gate 55S and a group of lower bits A11 to A9 of the address data currently sent through the address bus 5, the word line 58 is set to an active level, and the bus interface unit 3 actually gains access to the memory area of the replacing block area 44S corresponding to the memory area of the replaced block area 44_{B}. That is, the bus interface unit 3 automatically gains access to the replacing block area 44S in place of the replaced block area 44_{B} having bugs.

As is described above, in the first embodiment, the replacement information (the bits A17 to A12) indicating the replaced block area having bugs and the replacement enable bit ENB are written in the replacement information area or the register 66), correction data desired to be stored in the replaced block area is written in the replacing block area, and the access to the replacing block area is performed in place of the access to the replaced block area when the access to the replaced block area is intended. Therefore, the correction data stored in the replacing block area can be read out in place of erroneous data stored in the replaced block area having bugs, and the user can easily obtain the correction data even though bugs exist in an accessing area. Accordingly, correction of erroneous data based on bugs of the one-time program ROM 40 can be easily performed without enlarging a circuit size of the microcomputer. Also, because the 4 k-bytes replaced block area having bugs is replaced with the 4 k-bytes replacing block area, the bugs of the one-time program ROM 40 can be corrected regardless of a size of the bugs.

Also, in the first embodiment, only the hardware configuration of the replaced address register 6, the address comparator 7 and the word line decoder 43 is added to the microcomputer 1 to obtain the functions of the configuration, and only the replacing block area is additionally set in the address space of the ROM area 44. Accordingly, the increase of a chip area of the microcomputer can be reduced.

Embodiment 2

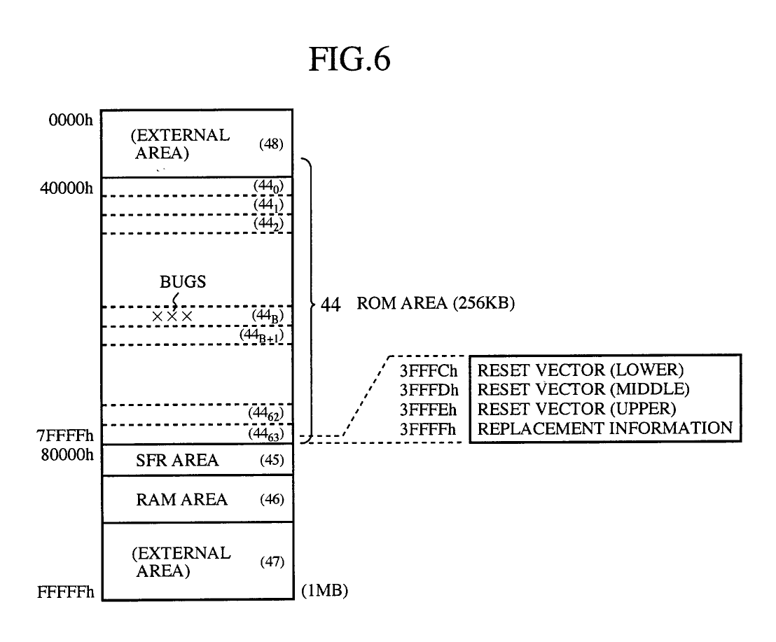

FIG. 6 shows a memory map in the memory cell array 41 of the one-time program ROM 40 according to a second embodiment of the present invention. In a second embodiment, the memory cell array 41 having the address space of a memory map shown in FIG. 6 is used in place of that of a memory map shown in FIG. 5.

In FIG. 6, the replacing block area 44S existing in the memory map shown in FIG. 5 does not exist in the memory map shown in FIG. 6, but the 4 k-byte memory area 44₀ is used in place of the replacing block area 44S. In other words, in cases where it is supposed that no bug exists in the ROM area 44 of the one-time program ROM 40, no block area replacement is performed in the microcomputer. In this case, pieces of data used in a normal operation are stored in the 4 k-byte memory area 44₀, and the bus interface unit 3 can gain access to the 4 k-byte memory area 44₀ placed at the addresses “40000h” to “40FFFh”. In contrast, in cases where it is supposed that bugs (or a bug) exist in the ROM area 44 of the one-time program ROM 40, the block area replacement is performed in the microcomputer. In this case, no data is stored in the 4 k-byte memory area 44₀ to set the 4 k-byte memory area 44₀ in a blank state. When bugs generated in a 4 k-byte memory area 44_{B} of the ROM area 44 are detected, correction data is stored in the 4 k-byte memory area 44₀.

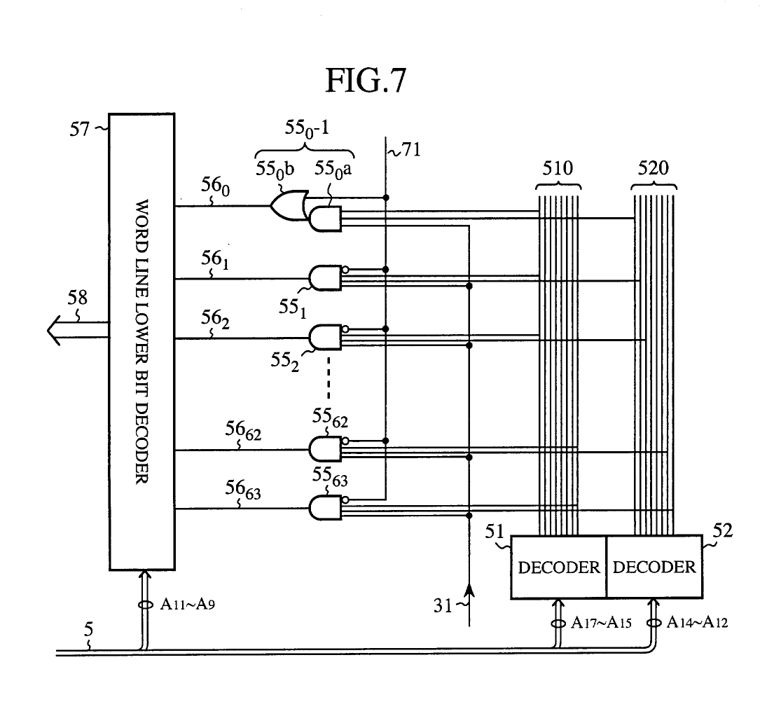

FIG. 7 is a constitutional view showing the word line decoder 43 according to the second embodiment. The constituent elements, which are the same as those shown in FIG. 4, are indicated by the same reference numerals as those of the constituent elements shown in FIG. 4, and additional description of those constituent elements is omitted.

The word line decoder 43 shown in FIG. 7 is arranged in the microcomputer 1 in place of that shown in FIG. 4, and the replaced address register 6 shown in FIG. 2 and the address comparator 7 shown in FIG. 3 are arranged in the microcomputer 1 in the same manner as in the first embodiment.

In FIG. 7, as compared with the word line decoder 43 in the first embodiment, the buffer gate 55S shown in FIG. 4 is not arranged in the word line decoder 43, and a composite gate 55₀-1 is arranged in the word line decoder 43 in place of the AND gate 55₀. The composite gate 55₀-1 is composed of an AND gate 55₀a and an OR gate 55₀b. The ROM area access signal (ROMar) 31 is received in the AND gate 55₀a, and one decoder output 510 and one decoder output 520 indicating the group of block address (“40000h” to “40FFFh”) of the 4 k-byte memory area 44₀ are received in the AND gate 55₀a. An output of the AND gate 55₀a and the address identity signal 71 output from the address comparator 7 are received in the OR gate 55₀b. An OR signal 56₀ is output from the OR gate 55₀b to the word line lower bit decoder 57.

In cases where it is supposed that no bug exists in the ROM area 44, pieces of data are stored in the 4 k-byte memory areas 44n in a writing operation. In the normal operating mode, when the bus interface unit 3 gains access to a memory area of the 4 k-byte memory area 44₀ of the block address (“40000h” to “40FFFh”), a high level signal is output from the AND gate 55₀a, and the OR signal 56₀ set to the high level is output from the OR gate 55₀b to the word line lower bit decoder 57 regardless of the address identity signal 71. That is, the composite gate 55₀-1 is set to an active state, one word line 58 corresponding to the memory area of the 4 k-byte memory area 44₀ is set to the active level, and data is read out from the memory area of the 4 k-byte memory area 44₀.

Also, in cases where bugs (or a bug) are generated in a 4 k-byte memory area 44_{B} of the ROM area 44, pieces of correction data desired to be stored in the 4 k-byte memory area 44_{B} are stored in the 4 k-byte memory area 44₀ of the ROM area 44. In the normal operating mode, when the bus interface unit 3 intends to gain access to a memory area of the 4 k-byte memory area 44_{B} having bugs, the address identity signal 71 is set to the active level, and the OR gate 55₀b is set to the active state. Therefore, the composite gate 55₀-1 is set to the active state. Also, the AND gates 55₀a and 55₁ to 55₆₃ are set to the inactive state according to the inverted address identity signal 71. Accordingly, the access to the 4 k-byte memory area 44_{B} is inhibited, and the correction data is read out from a corresponding memory area of the 4 k-byte memory area 44₀ in place of the reading-out of erroneous data from the accessed memory area of the 4 k-byte memory area 44_{B}.

As is described above, in the second embodiment, in cases where it is supposed that no bug exists in the ROM area 44 of the one-time program ROM 40, pieces of data used in a normal operation are stored in the 4 k-byte memory area 44₀. Also, in cases where it is supposed that bugs (or a bug) are generated in the 4 k-byte memory area 44_{B} of the ROM area 44, the 4 k-byte memory area 44₀ of the ROM area 44 is used as the replacing block area, and correction data desired to be stored in the 4 k-byte memory area 44_{B} is stored in the 4 k-byte memory area 44₀. Accordingly, it is not required to prepare the replacing block area in the ROM area 44 in addition to the 4 k-byte memory areas 44n, and a chip area of the microcomputer 1 can be further reduced as compared with that in the first embodiment.

Embodiment 3

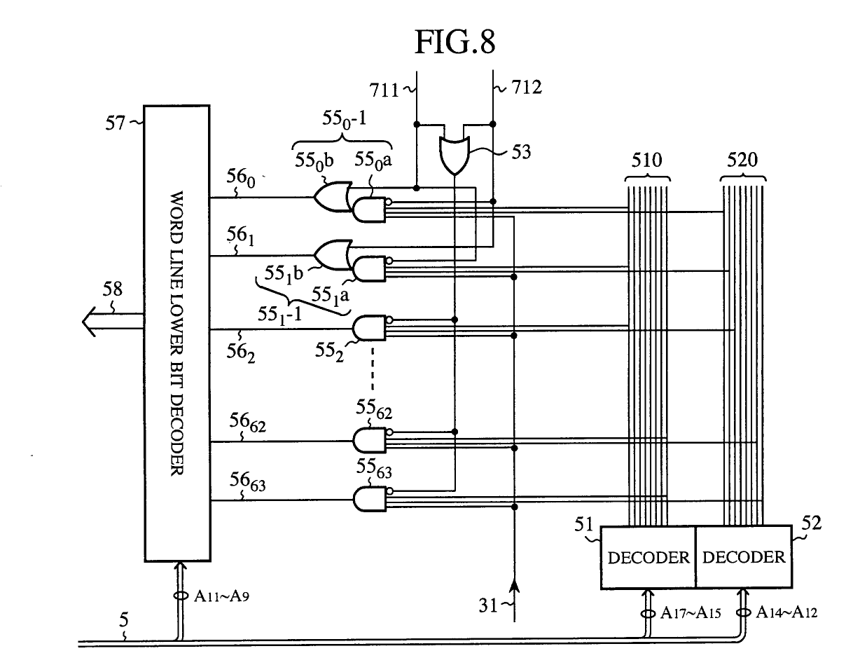

FIG. 8 is a constitutional view showing the word line decoder 43 according to a third embodiment. The constituent elements, which are the same as those shown in FIG. 4 or FIG. 7, are indicated by the same reference numerals as those of the constituent elements shown in FIG. 4 or FIG. 7, and additional description of those constituent elements is omitted.

In a third embodiment, the memory cell array 41 having the address space of the memory map shown in FIG. 6 is arranged in the microcomputer 1, a plurality of replaced address registers 6 shown in FIG. 2 and a plurality of address comparators 7 shown in FIG. 3 are arranged in the microcomputer 1, and each combination of the replaced address register 6 and the address comparator 7 corresponds to one replaced block area replaced with one replacing block area. To simplify the description of the third embodiment, two replaced address registers 6 shown in FIG. 2 and two address comparators 7 shown in FIG. 3 are arranged in the microcomputer 1, and bugs (or a bug) exist in two 4 k-byte memory areas 44_{B1} and 44_{B2} of the ROM area 44. However, it is applicable that K (K denotes an integral number equal to or higher than two) replaced address registers 6 and K address comparators 7 be arranged in the microcomputer 1. In this embodiment, the replacement information relating to the 4 k-byte memory area 44_{B1} is stored in one replaced address register 6, the replacement information relating to the 4 k-byte memory area 44_{B2} is stored in another replaced address register 6, an address identity signal 711 indicating the agreement of the 4 k-byte memory area 44_{B1} with an currently accessed block area is output from one address comparator 7, and an address identity signal 712 indicating the agreement of the 4 k-byte memory area 44_{B2} with an currently accessed block area is output from another address comparator 7.

In FIG. 8, the composite gate 55₀-1 and a composite gate 55₁-1 are arranged in the word line decoder 43 in place of the AND gates 55₀ and 55₁. The composite gate 55₁-1 is composed of an AND gate 55₁a and an OR gate 55₁b. The address identity signal 711 is received in the OR gate 55₀b and is received in the AND gate 55₁a through an inverter. The address identity signal 712 is received in the OR gate 55₁b and is received in the AND gate 55₀a through an inverter. The ROM area access signal (ROMar) 31 is received in the AND gate 55₀a, the AND gate 55₁a and the AND gates 55₂ to 55₆₃. Also, one decoder output 510 and one decoder output 520 indicating the group of block address (“40000h” to “40FFFh”) of the 4 k-byte memory area 44₀ are received in the AND gate 55₀a, and one decoder output 510 and one decoder output 520 indicating the group of block address (“41000h” to “41FFFh”) of the 4 k-byte memory area 44₁ are received in the AND gate 55₁a. An output of the AND gate 55₀a and the address identity signal 711 are received in the OR gate 55₀b. An output of the AND gate 55₁a and the address identity signal 712 are received in the OR gate 55₁b. An OR signal 56₁ is output from the OR gate 55₁b to the word line lower bit decoder 57. Also, an OR gate 53 is additionally arranged in the word line decoder 43. The address identity signals 711 and 712 are received in the OR gate 53, and an output of the OR gate 53 is received in each of the AND gates 55₂ to 55₆₃ through an inverter.

In cases where bugs (or a bug) exist in the 4 k-byte memory area 44_{B1} (or replaced block area 44_{B1}) and the 4 k-byte memory area 44_{B2} (or replaced block area 44_{B2}) of the ROM area 44, pieces of correction data desired to be stored in the 4 k-byte memory area 44_{B1} are stored in the 4 k-byte memory area 44₀ (or replacing block area 44₀) of the ROM area 44, and pieces of correction data desired to be stored in the 4 k-byte memory area 44_{B2} are stored in the 4 k-byte memory area 44₁ (or replacing block area 44₁) of the ROM area 44. In the normal operating mode, when the bus interface unit 3 intends to gain access to a memory area of the 4 k-byte memory area 44_{B1} having bugs or the 4 k-byte memory area 44_{B2} having bugs, the address identity signal 711 or the address identity signal 712 is set to the active level. In cases where the address identity signal 711 is set to the active level because of the access to one memory area of the 4 k-byte memory area 44_{B1}, the composite gate 55₀-1 is set to the active state, the AND gate 55₁a is set to the inactive state according to the inverted address identity signal 711, the OR gate 55₁b is set to the inactive state according to an output of the AND gate 55₁a and the address identity signal 712 set to the inactive level, and the composite gate 55₁-1 is set to the inactive state. Also, an OR signal set to a high level is output from the OR gate 53, and the AND gates 55₂ to 55₆₃ are set to the inactive state according to the inverted OR signal of the OR gate 53. Therefore, the access to the 4 k-byte memory area 44_{B1} is inhibited, and the correction data is read out from the corresponding memory area of the 4 k-byte memory area 44₀ in place of the reading-out of erroneous data from the memory area of the 4 k-byte memory area 44_{B1}.

Also, in cases where the address identity signal 712 is set to the active level because of the access to a memory area of the 4 k-byte memory area 44_{B2} the composite gate 55₁-1 is set to the active state, the composite gate 55₀-1 is set to the inactive state, and the AND gates 55₂ to 55₆₃ are set to the inactive state. Therefore, the access to the memory area of the 4 k-byte memory area 44_{B2} is inhibited, and the correction data is read out from the corresponding memory area of the 4 k-byte memory area 44₁ in place of the reading-out of erroneous data from the memory area of the 4 k-byte memory area 44_{B2}.

Also, in cases where no bug exists in the ROM area 44, when the bus interface unit 3 intends to gain access to one memory area of one 4 k-byte memory area 44i, the address identity signals 711 and 712 are set to the inactive level, only the AND gate 55₀a, 55₁a or 55i corresponding to the 4 k-byte memory area 44i is set to the active state, the memory area of the 4 k-byte memory area 44i is specified in the word line lower bit decoder 57, and data is read out from the memory area of the 4 k-byte memory area 44i.

As is described above, in the third embodiment, the combination of the replaced address register 6 and the address comparator 7 is arranged in the microcomputer 1 for each replaced block area having bugs, and one 4 k-byte memory area corresponding to each replaced block area having bugs and functioning as a replacing block area is selected. Accordingly, even though bugs exists in a plurality of replaced block areas, correction data desired to be stored in each replaced block area having bugs can be read out from the corresponding replacing block area.

Embodiment 4

In cases where correction data desired to be stored in a specific 4 k-byte memory area 44_{B} having bugs is stored in a replacing block area, because an amount of the bugs of the specific 4 k-byte memory area 44_{B} is large, there is probability that an amount of the correction data of the specific 4 k-byte memory area 44_{B} is too large to store -the correction data in only the replacing block area. Also, in cases where a user desires to correct a control program stored in a specific 4 k-byte memory area 44_{B} to a large degree, there is probability that an amount of a corrected control program is too large to store the corrected control program in only a replacing block area. In this case, it is effective that the correction data (or the corrected control program) required of the specific 4 k-byte memory area 44_{B} and original data already stored in a 4 k-byte memory area 44_{B+1} (or a group of 4 k-byte memory areas) following the specific 4 k-byte memory area 44_{B} are stored in a plurality of replacing block areas.

Therefore, in a fourth embodiment, in cases where an amount of bugs in original data of a 4 k-byte memory area 44_{B} or a degree of correction of a control program stored in a 4 k-byte memory area 44_{B} is large, the block area replacement is extended to a 4 k-byte memory area 44_{B+1} (or a group of 4 k-byte memory areas) adjacent to the 4 k-byte memory area 44_{B} to set the 4 k-byte memory area 44_{B+1} (or the group of 4 k-byte memory areas) as a replaced block area (or a plurality of replaced block area) in addition to the setting of the 4 k-byte memory area 44_{B} as a replaced block area, and correction data desired to be stored in the 4 k-byte memory area 44_{B} and the 4 k-byte memory area 44_{B+1} (or the group of 4 k-byte memory areas) successively arranged in the one-time program ROM 40 are read out from other 4 k-byte memory areas functioning as a plurality of replacing block areas in place of the reading-out from the 4 k-byte memory area 44_{B} and the 4 k-byte memory area 44_{B+1} (or the group of 4 k-byte memory areas).

In the fourth embodiment, the memory cell array 41 having the address space of the memory map shown in FIG. 6 is arranged in the microcomputer 1.

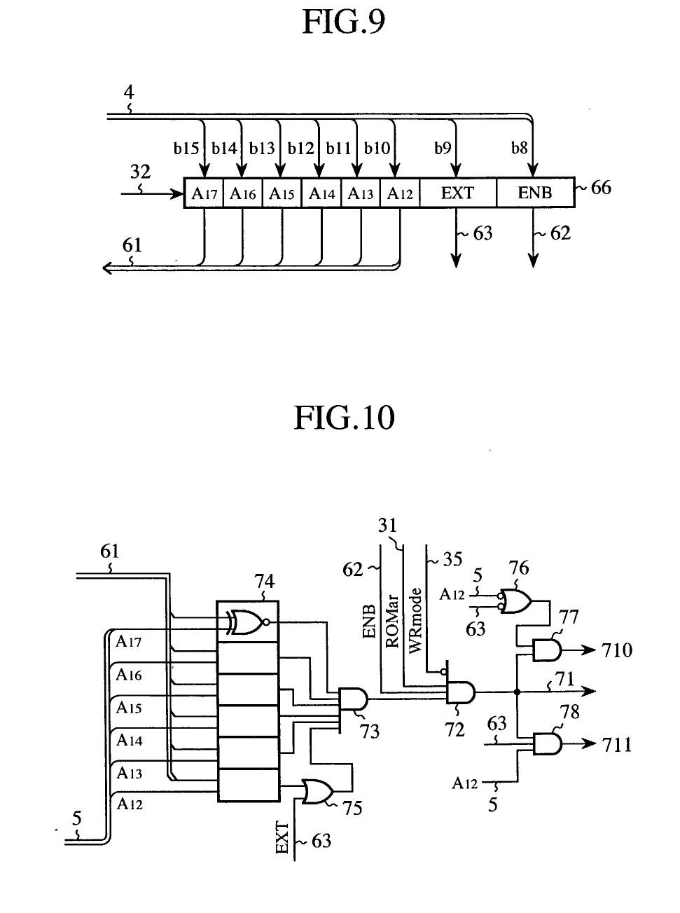

FIG. 9 is a constitutional view showing the replaced address register 6 shown in FIG. 1 according to the fourth embodiment. The constituent elements, which are the same as those shown in FIG. 2, are indicated by the same reference numerals as those of the constituent elements shown in FIG. 2, and additional description of those constituent elements is omitted.

In FIG. 9, an extension specifying bit EXT corresponding to the bit b9 of the replaced block area data sent through the data bus 4 is output from the replaced address register 6 as an extension specifying signal (or extension information) 63. In cases where an amount of correction data (or a corrected control program) desired to be stored in one 4 k-byte memory area denoting a replaced block area is too large to store the correction data (or the corrected control program) in only a 4 k-byte memory area denoting a replacing block area, the extension specifying signal 63 is set to the high level “1”. The extension specifying signal 63 set to “1” denotes extension specification for block area.

FIG. 10 is a constitutional view showing the address comparator 7 shown in FIG. 1 according to the fourth embodiment. The constituent elements, which are the same as those shown in FIG. 3, are indicated by the same reference numerals as those of the constituent elements shown in FIG. 3, and additional description of those constituent elements is omitted.

In FIG. 10, an OR gate 75, an OR gate 76, an AND gate 77 and an AND gate 78 are additionally arranged in the address comparator 7. The extension specifying signal 63 and an output of the EX-NOR gate of the comparing circuit 74 corresponding to both the bit A12 of the replaced address register output 61 and the bit A12 of address data currently sent, through the address bus 5 are received in the OR gate 75, and an AND signal obtained in the OR gate 75 is output to the AND gate 73. In cases where the extension specifying signal 63 is set to the high level, an AND signal set to the high level is always output from the OR gate 75 to the AND gate 73. Therefore, in cases where the bits A17 to A13 of the replaced address register output 61 agree with the bits A17 to A13 of the address data currently sent through the address bus 5, an AND signal set to the high level is output from the AND gate 73 regardless of the agreement of the bit A12 of the replaced address register output 61 with the bit A12 of the address data, and an address identity signal 71 set to the high level is output from the AND gate 72 in case of the replacement enabling indicated by the replaced address register output 62, the access to the one-time program ROM 40 indicated by the ROM area access signal (ROMar) 31 and an operation mode other than the writing operation mode. Accordingly, a comparison result of the bits A12 obtained in the comparing circuit 74 is invalidated in case of the extension specification (or extension specifying signal 63 set to “1”), and the number of 4 k-byte memory areas judged to be replaced with other 4 k-byte memory areas is doubled as compared with in the first embodiment.

In this embodiment, the bit A12 of the replaced address register output 61 output from the replaced address register 6 is set to “0”, the bits A17 to A13 of the replaced address register output 61 indicates the block address of both a 4 k-byte memory area 44_{B} and a 4 k-byte memory area 44_{B+1} adjacent to the 4 k-byte memory area 44_{B}, the bits A17 to A12 of the replaced address register output 61 indicates the block address of the 4 k-byte memory area 44_{B}. Therefore, the combination of the bits A17 to A13 of the replaced address register output 61 and the A12=“1” indicates the block address of the 4 k-byte memory area 44_{B+1}.

Also, an inverted value of the bit A12 of the address data currently sent through the address bus 5 and the inverted value of the extension specifying signal 63 are received in the OR gate 76. Therefore, in case of the extension specification, an OR signal set to “1” is output from the OR gate 76 when the bus interface unit 3 intends to access to the 4 k-byte memory area 44_{B} (in case of A12=“0” of the current address data), and an OR signal set to “0” is output from the OR gate 76 when the bus interface unit 3 intends to access to the 4 k-byte memory area 44_{B+1} (in case of A12=“1” of the current address data).

Also, the OR signal of the OR gate 76 and the address identity signal 71 are received in the AND gate 77. Therefore, in case of the extension specification, an address replacement signal 713 set to an active level “1” is output from the AND gate 77 when the bus interface unit 3 intends to access to the 4 k-byte memory area 44_{B} (in case of A12=“0” of the current address data), and an address replacement signal 713 set to an inactive level “0” is output from the AND gate 77 when the bus interface unit 3 intends to access to the 4 k-byte memory area 44_{B+1} (in case of A12=“1” of the current address data).

Also, the address identity signal 71, the extension specifying signal 63 and a value of the bit A12 of the address data currently sent through the address bus 5 are received in the AND gate 78. Therefore, in case of the extension specification, an address replacement signal 714 set to an inactive level “0” is output from the AND gate 78 when the bus interface unit 3 intends to access to the 4 k-byte memory area 44_{B} (in case of A12=“0” of the current address data), and an address replacement signal 714 set to an active level “1” is output from the AND gate 78 when the bus interface unit 3 intends to access to the 4 k-byte memory area 44_{B+1} (in case of A12=“1” of the current address data).

Also, in cases where the extension specifying signal 63 is set to the low level (no extension specification), when the bits A17 to A12 of the replaced address register output 61 agree with the bits A17 to A12 of the address data currently sent through the address bus 5, an address identity signal 71 set to the high level, an address replacement signal 713 set to the high level and an address replacement signal 714 set to the low level are output from the address comparator 7 in case of the replacement enabling, the access to the one-time program ROM 40 and an operation mode other than the writing operation mode. In contrast, when the bits A17 to A12 of the replaced address register output 61 do not agree with the bits A17 to A12 of the address data currently sent through the address bus 5, an address identity signal 71 set to the low level, an address replacement signal 713 set to the low level and an address replacement signal 714 set to the low level are output from the address comparator 7.

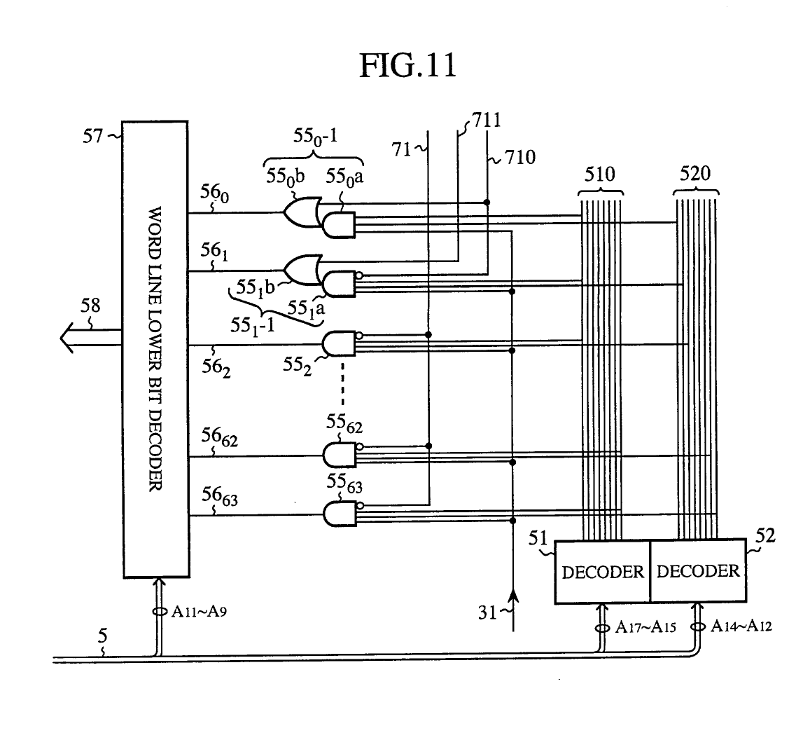

FIG. 11 is a constitutional view showing the word line decoder 43 according to a fourth embodiment. The constituent elements, which are the same as those shown in FIG. 4, are indicated by the same reference numerals as those of the constituent elements shown in FIG. 4, and additional description of those constituent elements is omitted.

In FIG. 11, the composite gate 55₀-1 and the composite gate 55₁-1 are arranged in the word line decoder 43 in place of the AND gates 55₀ and 55₁. The word line lower bit decoder 57 judges according to an OR signal 56₀ output from the OR gate 55₀b of the composite gate 55₀-1 to perform the access to the 4 k-byte memory area 44₀, and the word line lower bit decoder 57 judges according to an OR signal 56₁ output from the OR gate 55₁b of the composite gate 55₁-1 to perform the access to the 4 k-byte memory area 44₁. The address replacement signal 713 is received in the OR gate 55₀b and is received in the AND gate 55₁a through an inverter. The address replacement signal 714 is received in the OR gate 55₁b. The address identity signal 71 is received in each of the AND gates 55₂ to 55₆₃ through an inverter. The ROM area access signal (ROMar) 31 is received in the AND gate 55₀a, the AND gate 55₁a and the AND gates 55₂ to 55₆₃. Also, one decoder output 510 and one decoder output 520 indicating the group of block address (“40000h” to “40FFFh”) of the 4 k-byte memory area 44₀ are received in the AND gate 55₀a, and one decoder output 510 and one decoder output 520 indicating the group of block address (“41000h” to “41FFFh”) of the 4 k-byte memory area 44₁ are received in the AND gate 55₁a.

In case of the replacement enabling and the extension specification (or extension specifying signal 63 set to “1”), when the bus interface unit 3 intends to access to the 4 k-byte memory area 44_{B}, the address identity signal 71 set to the active level “1”, the address replacement signal 713 set to the active level “1” and the address replacement signal 714 set to the inactive level “0” are received in the word line decoder 43. Therefore, only the OR signal 56₀ output from the composite gate 55₀-1 is set to the active level “1”, the OR signal 56₁ output from the composite gate 55₁-1 and the AND signals 56₂ to 56₆₃ output from the AND gates 55₂ to 55₆₃ are set to the inactive level “0”, and the bus interface unit 3 accesses to the 4 k-byte memory area 44₀ in place of the 4 k-byte memory area 44_{B}. When the bus interface unit 3 intends to access to one 4 k-byte memory area 44_{B+1}, the address identity signal 71 set to the active level “1”, the address replacement signal 713 set to the inactive level “0” and the address replacement signal 714 set to the active level “1” are received in the word line decoder 43. Therefore, only the OR signal 56₁ output from the composite gate 55₁-1 is set to the active level “1”, the OR signal 56₀ output from the composite gate 55₀-1 and the AND signals 56₂ to 56₆₃ output from the AND gates 55₂ to 55₆₃ are set to the inactive level “0”, and the bus interface unit 3 accesses to the 4 k-byte memory area 44₁ in place of the 4 k-byte memory area 44_{B+1}.

In case of the replacement enabling and no extension specification (or extension specifying signal 63 set to “0”), when the bus interface unit 3 intends to access to the 4 k-byte memory area 44_{B}, the address identity signal 71 set to the active level “1”, the address replacement signal 713 set to the active level “1” and the address replacement signal 714 set to the inactive level “0” are received in the word line decoder 43. Therefore, the bus interface unit 3 accesses to the 4 k-byte memory area 44₀ in place of the 4 k-byte memory area 44_{B}. When the bus interface unit 3 intends to access to one 4 k-byte memory area other than the 4 k-byte memory area 44_{B}, the address identity signal 71 set to the inactive level “0”, the address replacement signal 713 set to the inactive level “0” and the address replacement signal 714 set to the inactive level “0” are received in the word line decoder 43. Therefore, the bus interface unit 3 accesses to the 4 k-byte memory area without performing the block area replacement.

In the fourth embodiment, though the replaced address register output 61 indicates only the specific 4 k-byte memory area 44_{B}, in case of the extension specification, the block area replacement is extended to both the specific 4 k-byte memory area 44_{B} and the 4 k-byte memory area 44_{B+1} adjacent to the specific 4 k-byte memory area 44_{B} according to he extension specifying bit EXT. However, in cases where N (N denotes a natural number) extension specifying bits EXT are used in the microcomputer 1, the block area replacement can-be extended to 2^{N} 4 k-byte memory areas in case of the extension specification.

As is described above, in the fourth embodiment, though the replaced address register output 61 indicates only one specific 4 k-byte memory area 44_{B}, the block area replacement can be performed for a plurality of 4 k-byte memory areas including the specific 4 k-byte memory area 44_{B} according to an amount of bugs existing in the specific 4 k-byte memory area 44_{B}. As a result, the block area replacement can be performed for the specific 4 k-byte memory area 44_{B} having bugs and another 4 k-byte memory area adversely influenced by the fixing of the bugs.

Also, in the fourth embodiment, because the block area replacement can be performed for a plurality of 4 k-byte memory areas adversely influenced by the fixing of the bugs of the specific 4 k-byte memory area 44_{B}, the4 k-byte memory areas can be arbitrarily selected.

Also, in the fourth embodiment, though the block area replacement is performed for a plurality of 4 k-byte memory areas in the same manner as in the third embodiment, because only one replaced address register 6 and only one address comparator 7 are arranged in the microcomputer 1, a chip size of the microcomputer 1 can be considerably reduced as compared with that in the third embodiment.

Embodiment 5

In a fifth embodiment, the memory cell array 41 having the address space of the memory map shown in FIG. 6 is arranged in the microcomputer 1. Also, the address comparator 7 shown in FIG. 3 is arranged in the microcomputer 1.

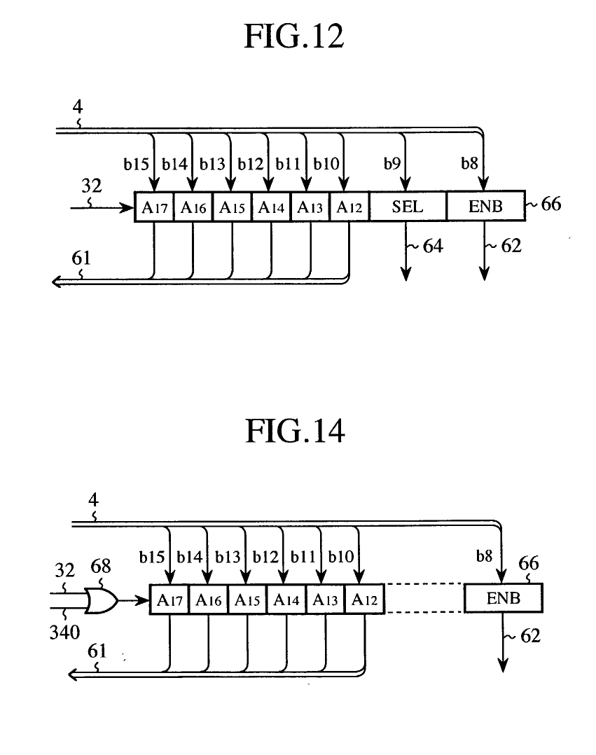

FIG. 12 is a constitutional view showing the replaced address register 6 shown in FIG. 1 according to the fifth embodiment. The constituent elements, which are the same as those shown in FIG. 2, are indicated by the same reference numerals as those of the constituent elements shown in FIG. 2, and additional description of those constituent elements is omitted.

In FIG. 12, a replacing area selecting bit SEL corresponding to the bit b9 of the replaced block area data sent through the data bus 4 is output from the replaced address register 6 as a replacing area selecting signal (replacing area selecting information) 64. As is described later in detail, one of a plurality of replacing block areas is selected according to the replacing area selecting signal 64.

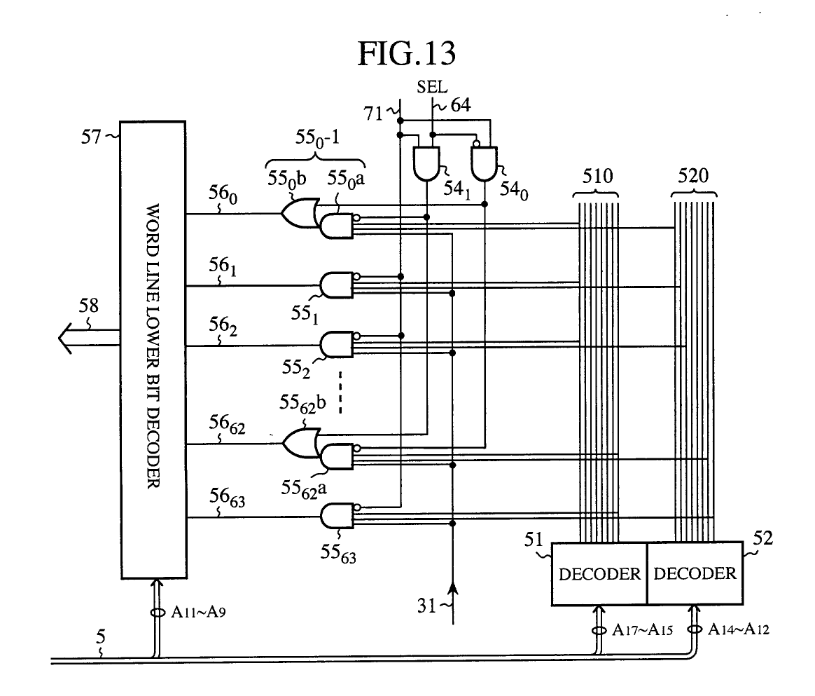

FIG. 13 is a constitutional view showing the word line decoder 43 shown in FIG. 1 according to the fifth embodiment. The constituent elements, which are the same as those shown in FIG. 4, are indicated by the same reference numerals as those of the constituent elements shown in FIG. 4, and additional description of those constituent elements is omitted.

In FIG. 13, the composite gate 55₀-1 and a composite gate 55₆₂-1 are arranged in the word line decoder 43 in place of the AND gates 55₀ and 55₆₂. The composite gate 55₆₂-1 is composed of an AND gate 55₆₂a and an OR gate 55₆₂b. One decoder output 510 and one decoder output 520 indicating the group of block address of the 4 k-byte memory area 44₆₂ are received in the AND gate 55₆₂a, an output of the AND gate 55₆₂a is received in the OR gate 55₆₂b, and an OR signal 56₆₂ is output from the OR gate 55₆₂b to the word line lower bit decoder 57. Also, an AND gate 54₀ and an AND gate 54₁ are arranged in the word line decoder 43. The address, identity signal 71 and an inverted,signal of the replacing area selecting signal 64 are received in the AND gate 54₀, and the address identity signal 71 and the replacing area selecting signal 64 are received in the AND gate 54₁.

An operation of the microcomputer 1 will be described on condition that the replacing area selecting signal 64 is set to the active level “1” because of the replacement enabling.

In cases where the replacing area selecting signal 64 is set in the low level “0”, when the bus interface unit 3 intends to access to a 4 k-byte memory area 44_{B} having bugs, an output of the AND gate 54₀ is set to the high level, and an output of the AND gate 54₁ is set to the low level. Therefore, the composite gate 55₀-1 is set to the active state, and the composite gate 55₆₂-1 and the AND gates 55₁, - - 55₆₁ and 55₆₃ are set to the inactive state. Therefore, the 4 k-byte memory area 44₀ is selected as a replacing block area according to the replacing area selecting signal 64 set in the low level, and the bus interface unit 3 accesses to the 4 k-byte memory area 44₀ in place of the 4 k-byte memory area 44_{B} having bugs.

Also, in cases where the replacing area selecting signal 64 is set in the high level, when the bus interface unit 3 intends to access to the 4 k-byte memory area 44_{B} having bugs, an output of the AND gate 54₀ is set to the low level, and an output of the AND gate 54₁ is set to the high level. Therefore, the composite gate 55₆₂-1 is set to the active state, and the composite gate 55₀-1 and the AND gates 55₁, - - 55₆₁ and 55₆₃ are set to the inactive state. Therefore, the 4 k-byte memory area 44₆₂ is selected as a replacing block area according to the replacing area selecting signal 64 set in the high level, and the bus interface unit 3 accesses to the 4 k-byte memory area 44₆₂ in place of the 4 k-byte memory area 44_{B} having bugs.

In the fifth embodiment, two composite gates are arranged in the microcomputer 1 to prepare two candidates for the replacing block area. However, it is applicable that a plurality of composite gates be arranged in the microcomputer 1 to prepare a plurality of candidates for the replacing block area.

As is described above, in the fifth embodiment, the replacing block area is selected from a plurality of candidates corresponding to a plurality of composite gates. Therefore, it is not required to prepare a specific 4 k-byte memory area in which no data is written in advance on the assumption that bugs are generated in one of the other 4 k-byte memory areas, and a 4 k-byte memory area not used for the operation of the microcomputer 1 can be selected as a replacing block area from a plurality of candidates corresponding to a plurality of composite gates. Accordingly, a degree of freedom in the design of the microcomputer 1 can be increased.

Also, in the fifth embodiment, even though bugs are generated in the replacing block area selected, another replacing block area not having bugs can be selected.

Embodiment 6

FIG. 14 is a constitutional view showing the replaced address register 6 shown in FIG. 1 according to a sixth embodiment. The constituent elements, which are the same as those shown in FIG. 2, are indicated by the same reference numerals as those of the constituent elements shown in FIG. 2, and additional description of those constituent elements is omitted.

In FIG. 14, an OR gate 68 is additionally arranged in the replaced address register 6. The replaced address register latch signal (CAlatch) 32 and a write signal 340 are input to the OR gate 68, an OR signal obtained in the OR gate 68 is input to the register 66. In cases where the OR signal is set to an active level “1”, the bits b15 to b10 and b8 of the replaced block area data sent through the data bus 4 are latched in the register 66. The write signal 340 is produced in an address recorder (not shown), and the write signal 340 is set to an active level “1” when the bits b15 to b10 and b8 of data are written in the replaced address register,6 by the bus interface unit 3. Therefore, the bits b15 to b10 and b8 of the replaced block area data produced in the CPU 2 can be set in the replaced address register 6 through the bus interface unit 3 according to the write signal 340.

In the sixth embodiment, the address comparator 7 shown in FIG. 3 and the word line decoder 43 shown in FIG. 4 are arranged in the microcomputer 1. Also, the memory cell array 41 having the address space of the memory map shown in FIG. 6 is arranged in the microcomputer 1.

Therefore, because the bits b15 to b10 and b8 of the replaced block area data are set in the replaced address register 6 according to the write signal 340, the data can be set in the replaced address register 6 under control of the CPU 2.

As is described above, in the sixth embodiment, because the data can be set in the replaced address register 6 under control of the CPU 2, when a function of the one-time program ROM 40 placed on a wafer is tested, circuit test for the address comparator 7 and the word line decoder 43 can be performed by reading out the data (or the control program) from the one-time program ROM 40 while changing the replaced block area data set in the replaced address register 6 and the address identity signal 71.

What is claimed is:

1. A microcomputer comprising:
a nonvolatile memory having a plurality of block areas and a replacement information area, first address information, which specifies a replaced block area included in the block areas, being stored in the replacement information area;
address information comparing means for comparing the first address information specifying the replaced block area with second address information indicating each block area of the nonvolatile memory currently accessed; and
access means for gaining access to one block area of the nonvolatile memory set in advance as a replacing block area in place of the access to the accessed block area indicated by the second address information in cases where the first address information agrees with the second address information in the comparison performed by the address information comparing means.

2. A microcomputer according to claim 1, wherein one block area of the nonvolatile memory possible to be accessed is set as the replacing block area regardless of the existence of the replaced block area.

3. A microcomputer according to claim 1, wherein the address information comparing means comprises a plurality of address information comparators for respectively comparing first address information specifying a replaced block area included in the block areas of the nonvolatile memory with the second address information indicating each block area of the nonvolatile memory currently accessed, and a plurality of replacing block areas are set in the nonvolatile memory to perform the access to each replacing block area in place of the access to the accessed block area indicated by the second address information in cases where the first address information agrees with the second address information in the comparison performed by the corresponding address information comparator.

4. A microcomputer according to claim 1, wherein the first address information stored in the replacement information area of the nonvolatile memory includes extension information which specifies a plurality of specific block areas including the replaced block area and successively arranged with each other in the nonvolatile memory as a plurality of replaced block areas, the first address information specifying each replaced block area is compared with the second address information by the address information comparing means, and the access means gains access to one block area of the nonvolatile memory set in advance as a replacing block area in place of the access to each replaced block area indicated by the extension information of the first address information.

5. A microcomputer according to claim 2, wherein the first address information stored in the replacement information area of the nonvolatile memory includes replacing area selecting information indicating a desired replacing block area which is selected from a plurality of block areas of the nonvolatile memory set in advance as a plurality of replacing block areas, and the access means gains access to the desired replacing block area indicated by the replacing area selecting information in place of the access to the accessed block area indicated by the second address information in cases where the first address information agrees with the second address information in the comparison performed by the address information comparing means.

6. A microcomputer according to claim 1, further comprising:
address information setting means for latching the first address information which specifies the replaced block area and is read out from a specific address of the nonvolatile memory at the start of an operation, wherein the first address information latched by the address information setting means is compared with second address information indicating each block area of the nonvolatile memory currently accessed by the address information comparing means.

7. A microcomputer according to claim 6, wherein the first address information is produced in a central processing unit and is latched by the address information setting means.
